(19) United States
(12) Patent Application Publication
(10) Pub. No.: US 2025/0083369 A1
(43) Pub. Date: Mar. 13, 2025

(54) PLASTICIZING UNIT

(71) Applicant: ENGEL AUSTRIA GmbH, Schwertberg (AT)

(72) Inventors: Thomas Koepplmayr, Marchtrenk (AT); Klaus Fellner, Steyr (AT)

(21) Appl. No.: 18/828,632

(22) Filed: Sep. 9, 2024

(30) Foreign Application Priority Data
Sep. 13, 2023 (DE) 20 2023 105 284.3

(51) Int. Cl. B29C 45/63; B29C 45/50; B29C 45/72

(52) U.S. Cl. CPC B29C 45/63; B29C 45/50; B29C 45/72

(57) ABSTRACT

A plasticizing unit for a molding machine includes a plasticizing screw arranged in a barrel so as to be rotatably driveable, and the screw is configured to plasticize a material. A feeding device is arranged on a lateral surface of the barrel, and the feeding device is configured to feed the material to be plasticized into the barrel. A dividing device divides the feeding device into two sub-regions. A first sub-region is configured to feed the material to be plasticized into the barrel, and a second sub-region is fluidically connected to a degassing device and/or an opening along the longitudinal axis of the barrel at one end of the barrel, through which opening the plasticizing screw is inserted into the barrel, is fluidically connected to the degassing device. The degassing device is configured to discharge gases generated during the plasticization of the material to be plasticized from the barrel.

### BACKGROUND OF THE INVENTION

The present invention relates to a plasticizing unit for a molding machine, as well as a molding machine with such a plasticizing unit.

Molding machines can include injection molding machines, injection presses, presses and the like. Molding machines in which the plasticized mass is fed into an open mold are also quite conceivable.

In the following, the prior art shall be outlined in the case of an injection molding machine. This analogously applies generally to molding machines.

Conventional plasticizing units comprise:
at least one plasticizing screw arranged in a barrel so as to be rotatably driveable, which screw is designed to plasticize a material to be plasticized, and
at least one feeding device arranged on a lateral surface of the barrel, which is designed to feed the material to be plasticized into the barrel.

Corresponding plasticizing units are used in injection molding machines to plasticize a material to be plasticized by a rotational movement of a plasticizing screw, whereby the material to be plasticized is plasticized by the shear energy, shear heat and, if necessary, externally supplied heat energy.

Corresponding plasticizing units are mostly designed as single or multi-screw extruders (also referred to as “single or multi-shaft extruders”).

After plasticization, this plasticized mass is either fed to a separate injection unit of an injection molding machine to inject the plasticized mass into a mold cavity in which it hardens to form a molded part, or the plasticizing screw itself is designed to be axially displaceable and can itself be used to inject the plasticized material (combined plasticizing and injection unit).

It is known from the prior art to use contaminated plastics as the material to be plasticized. These plastics can be, for example, recycled materials, regrinds and/or agglomerates, which are used, for example, in a recycling or compound application.

This topic is becoming increasingly important, wherein the recycling of materials to be plasticized (e.g. thermoplastics) allows them to be provided to a new use or application, thus creating a significant advantage in terms of environmental friendliness.

Of course, other further processing options are also possible. For example, the plasticized material can be fed into a continuous casting machine, an injection molding machine, a press, a semi-finished product production line or similar and then further processed with these.

However, the problem with compounding or recycling applications is that the plasticized mass still contains undesirable gases and inclusions in gaseous form after or during plasticizing, which lead to poor component quality during further processing. Such unwanted gases can be foreign substances such as residues from washing solutions or additives.

It is known from the prior art to degas the plasticized material in order to homogenize the melt and/or to prevent pore formation during further processing.

It is known from the prior art to provide corresponding degassing devices on the barrel of the plasticizing unit, wherein these degassing devices are to be connected to the plasticizing zone in the barrel so that the degassing device can extract gases released during plasticizing.

For this purpose, it is necessary to adapt the barrel accordingly, wherein special openings must be made in the barrel for these applications, which in turn must be sealed accordingly and care must be taken to ensure that no plasticized mass escapes through these degassing openings.

Furthermore, corresponding plasticizing units can only be used in combination with the degassing device, which not only requires increased manufacturing effort to produce a corresponding plasticizing unit, but also means that the plasticizing unit is subsequently restricted in its region of application by the degassing device.

A further disadvantage of the prior art is that existing plasticizing units cannot easily be supplemented by degassing devices, since the barrels of the plasticizing units have to be machined with corresponding complexity in order to be able to provide degassing devices.

### SUMMARY OF THE INVENTION

The object of the present invention is to at least partially improve the disadvantages of the prior art described above and/or to provide a plasticizing unit which can also be used for applications with masses to be degassed and plasticized and which is nevertheless associated with lower manufacturing costs and/or greater variability with regard to the field of application.

This object is achieved by a plasticizing unit for a molding machine described below, as well as a molding machine with such a plasticizing unit.

According to the invention, a plasticizing unit for a molding machine comprises:
at least one plasticizing screw arranged in a barrel so as to be rotatably driveable, which screw is designed to plasticize a material to be plasticized, and
at least one feeding device, which is arranged on a lateral surface of the barrel and which is designed to feed the material to be plasticized into the barrel.

A dividing device is provided which divides the feeding device into two sub-regions, wherein a first sub-region is designed to feed the material to be plasticized into the barrel and a second sub-region is fluidically connected to a degassing device, and/or
an opening along the longitudinal axis of the barrel at one end of the barrel, through which opening the at least one plasticizing screw is inserted into the barrel, is fluidically connected to the degassing device.

The degassing device is designed to remove gases generated during the plasticization of the material to be plasticized from the barrel.

In a first aspect, an existing feeding device can be used to perform degassing of the material to be plasticized during plasticization.

In a second aspect of the invention, an already existing opening at the end of the barrel, which opening serves to position the at least one plasticizing screw in the barrel, can be used to remove gases generated during the plasticization of the material to be plasticized from the barrel via the degassing device.

It is common to the aspects of the invention mentioned that a plasticizing unit can be designed which does not require separate, complex manufacturing measures on the barrel in order to nevertheless be able to carry out degassing during the plasticizing of a material to be plasticized, thereby creating the possibility of providing both existing systems of plasticizing units and new systems for plasticizing units which are not only intended for one degassing application, with the possibility of nevertheless being able to implement this application.

This means that a corresponding plasticizing unit can be subsequently removed from the degassing device and plasticizing can be carried out without degassing.

Furthermore, it is possible to use a corresponding degassing device for several molding machines, in particular injection molding machines, since the degassing device can be shared between the individual plasticizing units depending on the production.

Due to the lower manufacturing effort for producing a plasticizing unit according to the invention, the economic as well as ecological aspect of a molding machine can be improved.

The present invention makes use of the surprising finding obtained through tests by the applicant that it is not absolutely necessary to suction gases generated during plasticization in the region of the plasticizing zone of the barrel. Degassing via a feed opening/feeding device and/or degassing via the opening of the barrel, which serves to arrange the plasticizing screw in the barrel, also achieves the objective.

Furthermore, the plasticizing unit provided and the easy option of adding a degassing device can increase interest in applications for compounding and/or recycling applications, as corresponding plasticizing units for these applications are now easier to implement or even retrofit, so that the ecological benefits are naturally improved by the increased recycling of materials.

A device according to the invention can also be used and subsequently installed in already known embodiments of the prior art, as described, for example, in the introduction to the description.

Molding machines can include injection molding machines, injection presses, presses and the like. Also molding machines in which the plasticized mass is fed into an open mold are conceivable.

A mass to be plasticized can, for example, be a polymeric plastic material, preferably a thermoplastic.

Preferably, a control or regulating device can be designed to control or regulate:
at least one feeding device for feeding the material to be plasticized via the feeding device into the barrel, and
a drive unit of the at least one plasticizing screw.

The at least one feeding device can comprise a material conveyor and/or a further plasticizing device and/or at least one dosing 25 device. For example, the material to be plasticized can be fed into the barrel in a hardened state via the feeding device by the delivery device (if the material to be plasticized is preferably in the form of granules) or that the material to be plasticized has already been plasticized by another plasticizing device and is fed to the barrel in a plasticized state via the feeding device, with further plasticization of the material to be plasticized being carried out in the barrel (such applications are also often referred to as multi-stage plasticizing processes).

Preferably, the control or regulating unit is designed to underfeed the plasticizing screw. Underfeeding is a well-known process and means that the plasticizing screw is fed with less mass to be plasticized, for example via a feeding device (preferably a dosing device), than the plasticizing screw can convey in an intake zone.

As a result, the screw threads are only completely filled at a certain distance from an intake opening or the feeding device. From this point onwards, the pressure build-up in the plasticizing unit also begins.

If the effective screw length is extended accordingly by reducing the degree of underfeeding, a position of a pressure build-up moves towards a discharge opening of the barrel (thus moves away from the feeding device).

By means of the underfeeding, the intake zone of the at least one plasticizing screw can remain partially filled, thus ensuring an improved possibility for backwards degassing via the feeding device or the opening. Thanks to the improved degassing, easily volatile components can be extracted. This means that polymers can be processed particularly gently, in particular when plastic granules are used as the mass to be plasticized.

Preferably, the dividing device has a partition plate—preferably a perforated plate—which divides the feeding device into the two sub-regions.

The feeding device can have a filling funnel. Preferably, the fluid connection has a suction line, which particularly preferably projects into the second sub-region. The fluid connection can cover the opening through which the at least one plasticizing screw is inserted into the barrel, preferably in a gas-tight manner.

Furthermore, the degassing device for generating a negative pressure for degassing from the barrel comprises at least one conveying device, preferably which at least one conveying device comprises a fan, compressor and/or condenser. Preferably, the degassing device has at least one filter device.

The degassing device can have at least one separation device for separating liquid components from the gases discharged from the plasticizing process, and preferably the at least one separation device comprises a cyclone separator and/or a condensate trap.

Preferably, the degassing device has at least one cooling device, which is designed to cool the gases discharged from the plasticization. Cooling the gases discharged from the plasticizing process can be used to condense liquids dissolved in the gases in order to be able to release them from the gas and thus separate them from the gas.

The at least one plasticizing screw can be mounted and/or driven so as to be linearly displaceable in the barrel. The barrel can have a discharge opening, preferably an injection nozzle, along the longitudinal axis at a (second) end, which represents an end facing away from the opening.

### BRIEF DESCRIPTION OF THE DRAWINGS

Further examples, advantages and details of the invention are shown in the figures and explained in the following description of the figures, in which:

FIG. 1 shows a first exemplary embodiment of a plasticizing unit according to the invention,

FIG. 2 shows a second exemplary embodiment of a plasticizing unit according to the invention, and

FIG. 3 shows a molding machine with a plasticizing unit.

### DETAILED DESCRIPTION OF THE INVENTION

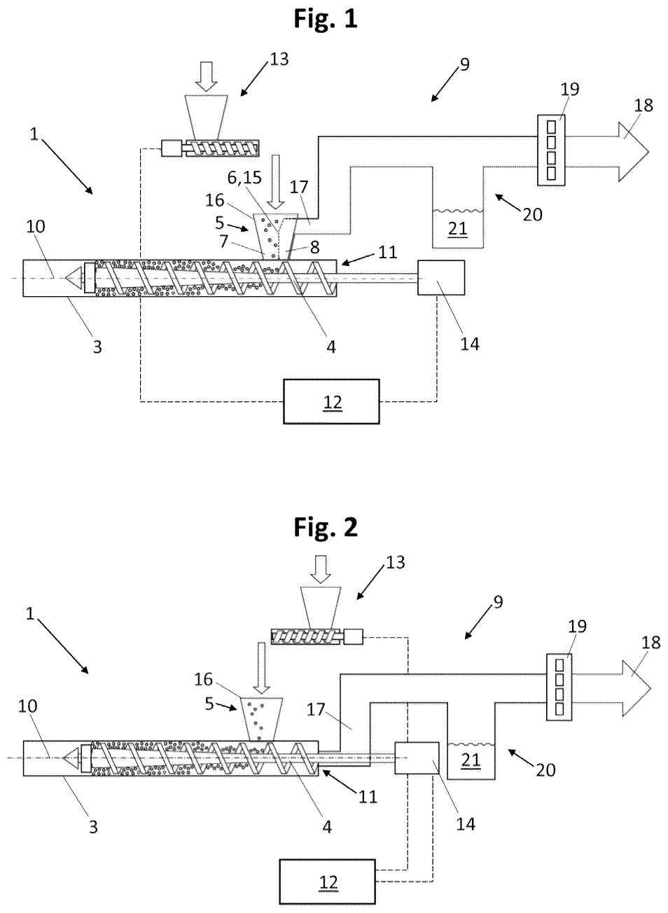

FIG. 1 shows a first embodiment of a plasticizing unit 1 according to the invention. The plasticizing unit 1 comprises a barrel 3 into which a plasticizing screw 4 is inserted via the opening 11. The opening 11 is located at a rear end of the barrel 3 along its longitudinal extension 10. As can be seen, the plasticizing screw 4 is mounted so that it can rotate and slide along the longitudinal axis 10 and can be driven via the drive 14.

A material to be plasticized can be fed to the barrel 3 via the feeding device 5. This feeding device 5 comprises a filling funnel 16, wherein the material to be plasticized—coming from the delivery device 13—is fed via the filling funnel 16 into the barrel 3 to the plasticizing screw 4. The feeding device 5 further comprises a corresponding opening in the barrel 3 in order to be able to feed the material to be plasticized into the interior of the barrel 3 of the plasticizing screw 4.

The controlled or regulated feed of the material to be plasticized is carried out via the delivery device 13, which in this embodiment is designed as an external dosing unit. A quantity and/or a mass flow of material to be plasticized, which is supplied via the feeding device 5 through the delivery device 13, can be controlled or regulated by the control or regulating device 12, which is connected to the delivery device 13 in a signal-conducting manner.

The control or regulating device 12 is further connected in a signal-conducting manner to the drive 14 of the plasticizing screw 4 and is designed to control or regulate a movement as well as a rotation of the plasticizing screw 4 via the drive device 14.

Furthermore, the plasticizing unit 1 comprises a dividing device 6 which divides the feeding device 5—or more precisely: in this exemplary embodiment, the filling funnel 16—into two sub-regions 7, 8. A first sub-region 7 is designed to feed the material to be plasticized into the barrel 3. A second sub-region 8 of this exemplary embodiment is designed to establish a fluidic connection with the degassing device 9.

For this subdivision, the dividing device 6 has a partition plate 15 so that the material to be plasticized is not mistakenly suctioned via the degassing device 9. The degassing device 9 is designed to discharge gases generated during the plasticization of the material to be plasticized from the barrel 3. For this purpose, the degassing device 9 comprises a suction line 17, which projects into the second sub-region 8 in order to carry out suction.

Furthermore, the degassing device 9 comprises a conveying device 18 for building up a negative pressure in order to suction the gas generated during the plasticization of the material to be plasticized.

In this exemplary embodiment, this conveying device 18 is only shown schematically by an arrow. Furthermore, the degassing device 9 comprises a separation device 20 for separating liquid components from the gases discharged from the plasticizing process, as well as a filtering device 19 for filtering suspended matter and/or particles from the gases discharged from the plasticizing process. The separation device 20 of this exemplary embodiment of the degassing device 9 is implemented as a condensate trap 21.

As can further be seen from FIG. 1, the control or regulating device 12 is designed, with the aid of the conveying device 18 and the drive 14, to underfeed the plasticizing screw 4. The plasticizing screw 4 is supplied with a smaller amount of material to be plasticized than it could accommodate in an intake region.

As shown in FIG. 1, it can be seen that only in a later region of the screw threads of the plasticizing screw 4 are the screw threads completely filled with material to be plasticized or already plasticized and a pressure build-up takes place.

A corresponding procedure (the underfeeding of the plasticizing screw 4) has shown that backwards degassing can be carried out in a particularly favorable manner via the degassing device 9 and good results can be achieved in the end product (the plasticized mass).

FIG. 2 shows a further exemplary embodiment of a plasticizing unit 1 according to the invention. In comparison to the embodiment of FIG. 1, the degassing device 9 in the exemplary embodiment of FIG. 2 is fluidically connected to the barrel 3 at the opening 11. This opening 11 of the barrel 3 is used to position and drive the plasticizing screw 4 in the barrel 3. Furthermore, in the exemplary embodiment according to the invention of FIG. 2 of the plasticizing unit 1, this opening 11 is used to suction gases generated during plasticizing out of the barrel 3 via the degassing device 9. For this purpose, the opening 11 of the barrel 3 is sealed tightly, preferably in a gas-tight manner, by the degassing device 9.

The remaining features of the embodiment of FIG. 2 (and thus of the plasticizing unit 1, the degassing device 9 and the delivery device 13) essentially correspond to the embodiment of FIG. 1.

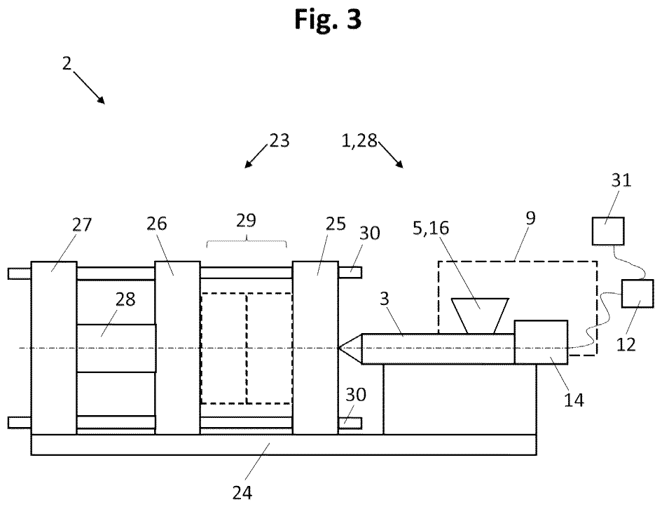

FIG. 3 shows an exemplary molding machine with an exemplary embodiment of a plasticizing unit 1 according to the invention. The molding machine 2 shown as an example in FIG. 3 is an injection molding machine and has a plasticizing unit 1 and a closing unit 23, which are arranged together on a machine frame 24. The machine frame 24 could alternatively be constructed in several parts. The closing unit 23 has a fixed mold clamping plate 25, a movable mold clamping plate 26 and a front plate 27. The movable mold clamping plate 26 is movable relative to the machine frame 24 via a symbolically represented toggle lever mechanism 28. Mold halves of a mold 29 can be clamped or mounted on the fixed mold clamping plate 25 and the movable mold clamping plate 26 (shown in dashed lines). The fixed mold clamping plate 25, the movable mold clamping plate 26 and the front plate 27 are supported and guided relative to one another by the spars 30.

The mold 29 shown closed in FIG. 3 has at least one cavity. An injection channel leads to the cavity, via which channel a plasticized mass can be fed to the plasticizing unit 1. The plasticizing unit 1 of this exemplary embodiment has a barrel 3 and a plasticizing screw 4 arranged in the barrel 3. This plasticizing screw 4 is rotatable about its longitudinal axis and can be moved axially along the longitudinal axis in the conveying direction in order not only to plasticize the mass to be plasticized, but also to inject it from the barrel 3 into the cavity of the mold 29. Corresponding exemplary embodiments of a plasticizing screw 4 are also often referred to as an injection screw.

These movements are driven by a schematically shown drive unit 14. Preferably, this drive unit 14 comprises a rotary drive for the rotary movement and a linear drive for the axial injection movement.

FIG. 3 shows a molding machine 2 with an injection unit 22, in which the injection unit 22 shown in this exemplary embodiment has an injection screw, which is also used for plasticizing a material to be plasticized. The plasticizing unit 1 (and thus the injection unit 22) is in signal connection with a control or regulating unit 12. The control or regulating unit 12 outputs control commands, for example, to the plasticizing unit 1 and/or the drive unit 14. The control or regulating unit 12 can be connected to an operating unit and/or a display device 31 or can be an integral part of such an operating unit.

Furthermore, the plasticizing unit 1 comprises a degassing device, indicated schematically in this figure, which can be connected to the plasticizing unit 1 according to an exemplary embodiment of FIG. 1 or FIG. 2.

### LIST OF REFERENCE NUMERALS

1 plasticizing unit
2 molding machine
3 barrel
4 plasticizing screw
5 feeding device
6 dividing device
7 first sub-region
8 second sub-region
9 degassing device
10 longitudinal axis
11 opening
12 control or regulating device
13 delivery device
14 drive device
15 partition plate
16 filling funnel
17 suction line
18 conveyor device
19 filtering device
20 separation device
21 condensate trap
22 injection unit
23 closing unit
24 machine frame
25 fixed mold clamping plate
26 movable mold clamping plate
27 front plate
28 toggle lever mechanism
29 mold
30 spar
31 display device

1. A plasticizing unit for a molding machine, comprising:
at least one plasticizing screw arranged in a barrel so as to be rotatably driveable, which screw is designed to plasticize a material to be plasticized; and
at least one feeding device arranged on a lateral surface of the barrel, which feeding device is designed to feed the material to be plasticized into the barrel,
wherein a dividing device is provided which divides the feeding device into two sub-regions, wherein a first sub-region is designed to feed the material to be plasticized into the barrel and a second sub-region is fluidically connected to a degassing device, and/or
wherein an opening, through which opening the at least one plasticizing screw is inserted into the barrel, is fluidically connected along the longitudinal axis of the barrel at one end of the barrel to the degassing device, and
wherein the degassing device is designed to discharge gases generated during the plasticization of the material to be plasticized from the barrel.

2. The plasticizing unit according to claim 1, further comprising at least one control or regulating device, which is designed to control or regulate:
at least one delivery device for feeding the material to be plasticized via the feeding device into the barrel, and
a drive unit of the at least one plasticizing screw.

3. The plasticizing unit according to claim 2, wherein the control or regulating unit is configured to underfeed the plasticizing screw.

4. The plasticizing unit according to claim 1, wherein the dividing device has a partition plate, preferably a perforated plate, which divides the feeding device into the two sub-regions.

5. The plasticizing unit according to claim 1, wherein the feeding device has a filling funnel.

6. The plasticizing unit according to claim 1, wherein the fluidic connection has a suction line, which preferably projects into the second sub-region.

7. The plasticizing unit according to claim 1, wherein the fluidic connection covers the opening through which opening the at least one plasticizing screw is inserted into the barrel, preferably in a gas-tight manner.

8. The plasticizing unit according to claim 1, wherein the degassing device for generating a negative pressure for degassing from the barrel comprises at least one conveying device, preferably which at least one conveying device comprises a fan, compressor and/or condenser.

9. The plasticizing unit according to claim 1, wherein the degassing device has at least one filter device.

10. The plasticizing unit according to claim 1, wherein the degassing device for separating liquid components from the gases discharged from the plasticizing has at least one separation device, which preferably comprises at least one separation device, a cyclone separator and/or a condensate trap.

11. The plasticizing unit according to claim 1, wherein the degassing device has at least one cooling device, which at least one cooling device is designed to cool the gases discharged from the plasticizing.

12. The plasticizing unit according to claim 1, wherein the at least one plasticizing screw is mounted and/or is drivable so as to be linearly displaceable in the barrel.

13. A molding machine, in particular an injection molding machine, with a plasticizing unit according to claim 1.
